(19) United States
(12) Patent Application Publication
(10) Pub. No.: US 2025/0049145 A1
(43) Pub. Date: Feb. 13, 2025

(54) Combination of a Vaporizer and a Charger and a Method of Outputting Information Related to a Combination of a Vaporizer and a Charger

(71) Applicant: JT International SA, Geneva (CH)

(72) Inventor: Layth Sliman Bouchuiguir, Bellevue (CH)

(73) Assignee: JT International SA, Geneva (CH)

(21) Appl. No.: 18/284,771

(22) PCT Filed: Mar. 28, 2022
(86) PCT No.: PCT/EP2022/058091

§ 371 Date: Sep. 28, 2023

(30) Foreign Application Priority Data
Mar. 29, 2021 (EP) 21165522.0

(51) Int. Cl. A24F 40/95; A24F 40/50; A24F 40/60

(52) U.S. Cl. CPC A24F 40/95; A24F 40/50; A24F 40/60

(57) ABSTRACT

A combination of a vaporizer and a charger has at least one user interface output such as a display and/or one or more light sources, in particular LEDs, and at least one user interface input such as buttons, capacitive touch sensors, and microphones for voice command input. All of the user interface outputs are provided on the vaporizer, and the charger lacks any of the user interface outputs. The vaporizer has at least one of the user interface inputs. Preferably no information can be input on the charger.

### TECHNICAL FIELD

The invention relates to a combination of a vaporizer and a charger as well as a method of outputting information relating to such a combination.

### BACKGROUND

Vaporizers have a recently gained popularity as an alternative to traditional smoking articles. Since the energy for heating an aerosol or a tobacco stick is provided electrically, the vaporizer needs to be charged and is, therefore, typically combined with a charger which can for example be a portable charging case, in which the vaporizer can be accommodated. Usually in such combinations, both the vaporizer as such and the charger have a user interface with one or more inputs, such as buttons or capacitive touch sensors and one or more outputs, such as LEDs for showing information such as battery level, vaping time, heating-up time and puff intensity.

In this context, U.S. Pat. No. 9,854,846 B2 is related to a charging package for an e-cigarette, which has a window, through which light from an LED provided on the e-cigarette can be emitted. Further e-cigarettes having user interface outputs are shown in GB 2528711 B and CN 107997236 A.

Other examples of the prior art can be seen in documents EP 371 1 577 A1, US 2020/112188 A1, US 2013/042865 A1 and CN 203 388 261 U.

### SUMMARY OF THE INVENTION

Against this background, it is an object underlying the invention to provide a combination of a vaporizer and a charger having an easy-to-handle user interface.

This object is achieved by the subject-matter of claim 1, according to which any outputs are provided on the vaporizer, which further has at least one input, and the charger lacks any such outputs and preferably also inputs.

For the sake of explanation, user outputs can be constituted by one or more displays or light sources, in particular LEDs, and inputs can be constituted by buttons, capacitive touch sensors or microphones for voice command input. As compared to today's common vaporizers or vaping devices in combination with chargers, the subject-matter of the present application simplifies the use thereof, since the user does not have to pay attention to outputs provided on two separate devices, the vaporizer on the one hand and the charger on the other hand, but can receive all information from outputs provided on the vaporizer only. The same preferably applies to any inputs. In other words, the user can operate the vaporizer and the charger or input any information into the combination of the two, by using input only provided on the vaporizer and does not have to worry about further inputs provided on the charger. This significantly simplifies the use of the vaporizer, which is individually combined with a charger, since both components are operated and can provide information to the user via the vaporizer only. Nevertheless, also the charger can have one or more inputs. It should also be mentioned that the vaporizer preferably has a single output and/or a single input, and the charger preferably has a single input.

Preferred embodiments are described in the further claims.

Handling of the combination or vaporizing system comprising the vaporizer and the charger can further be simplified by providing the charger as a charging case, which is preferably portable, and in which the vaporizer can be accommodated.

In order to provide the user with necessary or at least useful information, at least one output is related to battery level of the vaporizer or the charger, vaping time, heating-up time, puff intensity or charging state. All of these outputs will provide useful information to the user.

In accordance with the invention, in order to allow the user to distinguish between vaporizer and charger related output, a control can be provided, which is adapted to control at least one output so as to distinguish between vaporizer and charger related output. Distinguishing between vaporizer and charger related output can for example be achieved by a difference in representation or display of the output, such as the colour of a light source such as an LED, display of a different pattern, an additional light source, such as an LED or similar means.

In this context, it provides further advantages, if the control is adapted to control at least one output so as to output, in particular show vaporizer related output, when the vaporizer is not connected to the charger and to output charger related output, when the vaporizer is connected to the charger. In this manner, the user can easily grasp not only the information as such, but also the fact, to which of the two components the information is related. In particular, switching between vaporizer and charger related output can be effected automatically, depending on the result of detection, whether the vaporizer is connected to the charger. Alternatively, this switching can be affected by using the vaporizer's and/or charger's input.

This is further supported by the optional feature that the vaporizer has an output indicating whether vaporizer or charger related output is output.

In order to easily switch between vaporizer and charger related output, the vaporizer and/or the charger can have an input adapted to switch between the above-mentioned types of output.

The ease of use can be further improved by means of the optional feature, that the vaporizer has a single output and/or input, and/or the charger has a single input.

The invention further provides a method of outputting and inputting information to a combination of a vaporizer and a charger corresponding to the combination of devices described above, i.e. any information is output on the vaporizer, and no information is output on the charger, further allowing information to be input on the vaporizer, whereas at least preferably no information can be input on the charger. The method according to the invention simplifies the use of the described combination, and the preferred method features correspond to the preferred device features described above. In this context, it should generally be mentioned, that any features described in connection with the devices and the combination of vaporizer and charger can be provided in the method described herein and vice versa.

### BRIEF DESCRIPTION OF THE DRAWINGS

In the following, the invention will be described by exemplary embodiments thereof based on the drawings, in which

FIG. 1 shows a perspective view of a first embodiment; and

FIG. 2 shows a perspective view of a second embodiment.

### DETAILED DESCRIPTION OF PREFERRED EMBODIMENTS

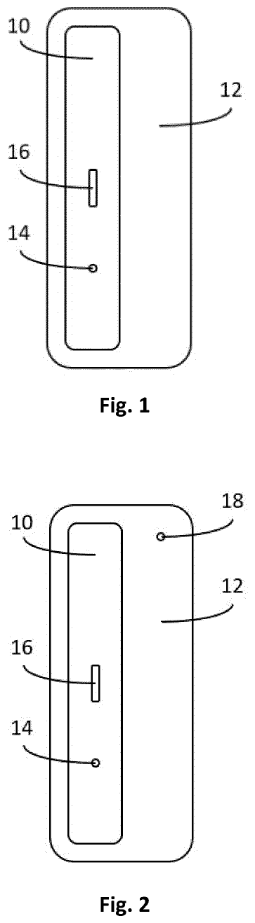

As can be taken from FIG. 1, the combination of a vaporizer 10 and a charger 12 can for example be provided in an elongate form, in which the charger is provided as a charging case, in which the vaporizer 10 can be accommodated. In the embodiment shown, the vaporizer comprises a button 14 as an example for an input, and an LED 16 constituting an example for an output. The button can for example be pressed in order to display a battery level of the vaporizer by means of the LED. Further, the control can be adapted to display battery level of the charger, when the button 14 is pressed again. The fact that now battery level of the charger is displayed by the LED, can be indicated by changing the colour of the LED, for example from white to green.

In the embodiment shown in FIG. 2, input and output are provided essentially in the same manner on the vaporizer, but the charger additionally has an input button 18. The button 14 on the vaporizer 10 can for example be used to control the LED to display battery level of the vaporizer, whereas for example the battery level of the charger is shown, as soon as the button 18 on the charger is pressed. In any case use and operation of the vaporizer combined with the charger is significantly simplified, so that user benefit is increased.

As can be seen in both figures, the vaporizer 10 is essentially elongate and covers essentially one entire side surface of the charger 12. The LED 16 can be provided essentially at the center of the vaporizer 10, and its input 14 can be provided at essentially one forth to one third of its length at approximately the center of the smaller dimension of the vaporizer 10 (from left to right in the figures). The input 18 of the charger can be provided at the end opposite the vaporizer's input 14 and approximately at the center of the larger side face of the charger 12.

1. A combination of a vaporizer and a charger comprising:
at least one user interface output;
at least one user interface input; and
a control,
wherein all of the at least one user interface outputs are provided on the vaporizer (10), the charger lacking any of the at least one user interface output, and wherein the vaporizer includes at least one of the at least one user interface input;
wherein the control is adapted to control at least a first one of the at least one user interface output so as to distinguish between output information related to the vaporizer and output information related to the charger.

2. The combination of claim 1, wherein the charger is a charging case; in which the vaporizer can be accommodated.

3. The combination of claim 1, wherein at least one item of output information is related to a battery level of the vaporizer or the charger, vaping time, heating up time, puff intensity, or charging state.

4. The combination of claim 1, wherein the control is adapted to control the first one of the at least one user interface output so as to show output information related to the vaporizer when the vaporizer is not connected to the charger, and so as to show output information related to the charger when the vaporizer is connected to the charger.

5. The combination of claim 1, wherein the first one of the at least one user interface output on the vaporizer indicates whether output information related to the vaporizer or output information related to the charger is output.

6. The combination of claim 1, wherein at least a first one of the at least one user interface input of the vaporizer and/or the charger is adapted to switch at least the first one of the at least one user interface output between output information related to the vaporizer and output information related to the charger.

7. The combination of claim 6, wherein the vaporizer has a single one of the at least one user interface output and/or the at least one user interface input, and/or wherein the charger has a single one of the at least one user interface input.

8. A method of outputting information related to a combination of a vaporizer and a charger comprising:
outputting, by means of at least one user interface output on the vaporizer, at least one item of output information, with no item of output information being output on the charger; and
inputting at least one item of input information on the vaporizer, with no item of input information being input on the charger; and
controlling the at least one item of output information in a manner so as to distinguish between output information related to the vaporizer and output information related to the charger.

9. The method of claim 8, wherein the at least one item of output information is related to at least one of a battery level of the vaporizer or the charger, vaping time, heating up time, puff intensity, or charging state is output.

10. The method of claims 8, wherein controlling the at least one item of output information includes showing output information related to the vaporizer when the vaporizer is not connected to the charger, and showing output information related to the charger when the vaporizer is connected to the charger.

11. The method of claim 8, wherein outputting the at least one item of output information includes indicating whether output information related to the vaporizer or output information related to the charger is output.

12. The method of claims 8, wherein outputting the at least one item of output information includes switching between output information related to the vaporizer and output information related to the charger.

13. The combination of claim 1, wherein the at least one user interface output includes a display and/or one or more light sources.

14. The combination of claim 13, wherein the one or more light sources includes LEDs.

15. The combination of claim 1, wherein the at least one user interface input includes buttons, capacitive touch sensors, and microphones for voice command input.

16. The combination of claim 2, wherein the charging case is portable.

17. The method of claim 8, wherein the at least one user interface output includes a display and/or one or more light sources.

18. The method of claim 17, wherein the one or more light sources includes LEDs.
